(19) United States
(12) Patent Application Publication
(10) Pub. No.: US 2018/0049442 A1
(43) Pub. Date: Feb. 22, 2018

(54) Bactericidal nanopreparation

(71) Applicants: Zygmunt Szymanski, Ryki (PL); Jerzy Peszke, Kruszyna (PL)

(72) Inventors: Zygmunt Szymanski, Ryki (PL); Jerzy Peszke, Kruszyna (PL)

(21) Appl. No.: 15/125,429

(22) PCT Filed: Mar. 12, 2015
(86) PCT No.: PCT/IB2015/051799

§ 371 Date: Sep. 12, 2016

(30) Foreign Application Priority Data
Mar. 13, 2014 (PL) P.407540

(51) Int. Cl. A01N 59/16; A01N 25/00

(52) U.S. Cl. CPC A01N 59/16; A01N 25/00

(57) ABSTRACT

A bactericidal preparation to be applied in ventilation and air-conditioning equipment is characterised in that it comprises a nanosilver component in colloidal form containing nanosilver particles in an amount of 5-4000 ppm complexed with polyvinyl alcohol (PVA) in an amount of 0.01-15%, in the presence of sodium or potassium nitrate at pH from 4.8 to 6.2 and a stabiliser dispersant in an amount of 0.01-12%, and, preferably, in the presence of a polymer in the form of ethyl polymethacrylate with molecular mass of 0.01-4000 kDa, said nanosilver component having been modified in the presence of nitric acid with polyethylene glycol with molecular mass of 400 at an amount of 0.1-45% and 30% hydrogen peroxide in an amount of 0.1-100 g/L.

The subject of the present invention is a bactericidal nanopreparation applicable in ventilation and air-conditioning devices.

The widespread use of ventilation and air conditioning systems is linked to the growing intensity of allergy symptoms and infections of the upper respiratory tract. In the 70- and 80-ies of the 20th century, it was noted that in air-conditioning equipment—especially if serviced occasionally or not serviced at all—pathogens develop that can cause severe respiratory diseases. A striking example of this was an instance of Pontiac fever in the Department of Health building in Pontiac in 1968 and severe respiratory failure at the Veterans Meeting at the Bellevue-Stratford Hotel in Philadelphia in July 1976. In both cases, the main source of infection were the air conditioning systems of the buildings, which were a source of disease-causing pathogens.

In view of the above, a fundamental issue related to air conditioning units is their careful maintenance, servicing, cleaning and decontamination. As practice shows, these conditions, being the key to the proper functioning of an air conditioning unit, are not always met. This can be attributed to both maintenance service price as well as an offset in a service schedule, for example due to the need to keep the operation of the equipment. In such a case, in order to at least limit the spread of pathogens in these devices, HEPA-type filters are used or a partial disinfection of the equipment using chemicals is carried out. Unfortunately, as practice shows, only full cleaning and disinfection of equipment guarantees protection against harmful pathogens. Even the smallest source of harmful organisms causes their expansion into the room. This is related to the specific features of these devices, because in addition to maintaining a constant temperature and air exchange, they allow for setting a constant, pre-set humidity. For this reason, in places where there are optimal conditions for development of pathogens, they will grow and, subsequently, spread across the room.
Chemical disinfectants used to limit the development of pathogens in these devices are based mainly on active forms of oxygen (ozone, hydrogen peroxide), alcohols and detergents. In a very limited extent, chlorine-based organic compounds and systems are used. Specifics of the application and the structure also imply the limited use of chemicals for these purposes. It is for this reason, among other things, that cleaning and disinfection of the air conditioning equipment can be carried out when the equipment is removed from operation. After this action, the chemical agent must be decomposed in order to eliminate the risk of it being inhaled by people. In view of the above, unit costs of maintenance of this type of equipment are very high. Some by-pass to these problems is the application of physical methods of elimination of pathogens from ventilating ducts. Solutions of this type are based on UV radiation to destroy the pathogens. In addition, the radiation causes the formation of ozone in the air stream, which destroys micro-organisms by a chemical route.
This type of solution is described in the patent application WO 2004105804 (A2), describing the use of a UV radiation generating equipment in a ventilation channel, and the related effects. The advantage of this type of solution is partial avoidance of chemistry to reduce the development of harmful microorganisms, especially bacteria of the genus Legionella. However, the effectiveness of this type of solution is limited in the case of equipment downtime, as harmful pathogens can freely thrive during this time in places where no biocidal agent arrives.
A similar solution, using a combined biocidal effect of UV radiation, is described in the patent application WO 1995026486 A1. In addition, small water droplets are fed to the air conditioner system, so the system can keep constant air humidity.
In U.S. patent application 5755103, UV radiation has been additionally used to disinfect water harvested in the vaporiser; such water could become a reservoir of harmful micro-organisms. Both of these solutions do not eliminate the primary drawback of this type of solution, namely, active combating of pathogens in case of a shutdown not due to maintenance.

Also known from the description of the European application EP2663184 is an invention concerning imparting antimicrobial properties to flexible connectors used in ventilation systems, using silver particles in the form of nanocapsules.

The present invention solves the issue of obtaining a nanopreparation which is an appropriately modified silver nanomaterial, preferably using a polymer in the form of ethyl methacrylate, applied to a heat exchanger system with the addition of substances which permanently bind the applied material. A combination of appropriately modified silver ions and a specially selected polymer forms an active anti-pathogen system. The solution according to our invention allows for effective combating of harmful micro-organisms in heat exchangers of a ventilating device adapted by design to suit that purpose. The active medium acting destructively on pathogens is a specially selected blend of polymers and silver nanomaterials which is applied onto the surface of an exchanger. This eliminates the need to use chemical disinfectants. The solution according to the present invention does not eliminate the possibility of using an additional source of biocidal agents in the form of UV radiation. The use of both of these systems operating synergistically increases the effectiveness of the whole device, and thus improves indoor air quality. However, the main factor in the quantitative reduction of pathogens during both operation and downtime is the layer of the biocidal preparation deposited onto the heat exchanger system or other place where the flow of air causes its contact with the preparation.

The bactericidal preparation is characterised in that it comprises a nanosilver component in colloidal form containing nanosilver particles in an amount of 5-4000 ppm complexed with polyvinyl alcohol (PVA) in an amount of 0.01-15%, in the presence of sodium or potassium nitrate at pH from 4.8 to 6.2 and a stabiliser dispersant in an amount of 0.01-12%, and, preferably, a polymer on the form of ethyl polymethacrylate with molecular mass of 0.01-4000 kDa, said nanosilver component being modified in the presence of nitric acid with polyethylene glycol with molecular weight of 400 in an amount of 0.1-45% and hydrogen peroxide with a concentration of 30% in an amount of 0.1-100 μg/litre.

Preferably, the polymer component is in the form of a dispersion.
Preferably, the stabilizer dispersant is polyoxyethylene sorbitol mono oleate (Tween).

The nanopreparation according to the present invention, which is a specially selected blend of silver nanomaterials preferably with the addition of a polymer, especially ethyl polymethacrylate, when applied on the heat exchanger or other place where the flow of air causes its contact with the preparation causes the reduction of pathogens during both the operation and the downtime of the unit. The reduction of pathogens is full and in a short period of time, within a period of approx. 1 h.

These effects are possible by complexing silver ions with polyvinyl alcohol in the presence of a dispersant, preferably polyoxyethylene sorbitan monooleate and sodium nitrate. Polyvinyl alcohol allows, at the same time, a durable bonding of the nanocomplex to the surface protected. In case of application of the nanopreparation to the surface protected by immersion, a permanent bonding of the nanocomplex to the protected surface (linker) is provided by a specially selected polymer in the form of ethyl polymethacrylate dispersion. For proper maintaining of the entire system potassium nitrate is used; additionally, to avoid a further reaction of spontaneous silver ions reduction, an oxidizer-perhydrol-is fed to the mixture. All the components, when used in quantities according to the invention, produce bactericidal synergism.

### EXAMPLE 1

3.4 g of silver nitrate was dissolved in 500 ml of water with a conductivity of less than 20 microsiemens. The whole quantity was placed on a high speed stirrer and stirring was carried out at 15 thousand rpm. Next, there was added to the solution 7 g of potassium nitrate, 2 g of sodium nitrate, and, subsequently, 5 g 8% polyvinyl alcohol (PVA). The whole mixture was stirred until obtaining a uniform colloid for at least 10 min. The complexing degree of silver ions was tested by semiconductor laser. After obtaining a homogeneous line of the laser beam, the mixture was again stirred, with the addition of 2 ml of 65% nitric acid and 5 ml of polymer dispersion of ethyl methacrylate (OSAKRYL ADG) having a dry matter content of 50%. After thorough mixing—20 min, 30 ml of 30% perhydrol and 2.5 ml of polyethylene glycol (PEG 400) was added to the solution. The whole mixture was stirred for another 20 min. The finished product was made up with water to 1 kg.
The preparation thus obtained is preferably applied onto the material to be protected by dipping.

### EXAMPLE 2

3.5 g of silver acetate was placed in a 200 ml glass container; 20 ml of concentrated 25% ammonia and 100 ml of water was added. The whole quantity was placed on a magnetic stirrer and stirred until the mixture was completely dissolved. The solution was filtered, and the filtrate made up to 500 ml with water and placed on a high speed stirrer-12 000 rpm. During the mixing of the solution concentrated 65% nitric acid was added to the solution until its pH had reached min. 3. Next, 6 g of potassium nitrate, 2 g of acetylsalicylic acid (aspirin) and 8 g of 5% solution of PVA was added. The mixture was thoroughly stirred for at least 20 minutes. After that time, the result of ions complexing was tested using CO₂ laser. After the Tyndall effect had been observed, 2 g of nitric acid was added to the solution. A straight laser line meant the proper complexing of ions. Then mixing was started again at 12 thousand rpm, 5 ml of perhydrol, 10 ml of isopropanol and 2 ml of PEG 400 was added. After thorough mixing for 20 min, the solution was made up with water to 1 kg. Preferably the obtained preparation is applied onto the material protected by spraying.
Application of the Preparation onto a Heat Exchanger Construction.
The preparation must be diluted to the appropriate concentration before application. Depending on silver content, dilution of 200-800 ppm is used. Only distilled water mixed with ethanol at 50:50 or 70:30 in favour of water is used for dilution. Ethanol used for dilution must not be contaminated with bitrex or any other solid contaminants and non-volatile liquids. The application of the preparation can be done by spraying or immersion; in the case of immersion ethyl polymethacrylate is added to the nanosilver material. After the spraying or immersion, binding of the preparation to the substrate will take place directly on the material to be protected.
Analysis of Antibacterial Activity of Materials with Nanosilver Deposited on them was Carried Out on a Bacterial Model of the Family Legionellaceae.
The material having surface of 4 cm² with silver nanoparticles and a control material without silver was placed in 1 ml of bacterial suspension of Legionella pneumophila stereotype 1 (ATCC 33152) (OD620=0.2) and incubated for one hour at 37° C. in an atmosphere of 5% CO₂. The culture was shaken at 120 rpm. Then, a series of dilutions was performed of the incubated bacterial suspension with the test sample and the control material, and from each dilution 20 μl were spilled on a BCYE plate (Buffered Charcoal Yeast Extract) with cysteine and antibiotics (GVPC: glycerine, vancomycin, polymyxin and cycloheximid). The plates were incubated for three days at 37° C. in a damp atmosphere at 5% CO₂ (Galaxy 1705, incubator, New Brunswick), and then the grown colonies were counted. The analysis was performed in a three-time repetition. The data presented in the table are the arithmetic mean of the results obtained.

TABLE
Average number of colonies of Legionella pneumophilia serotype 1
after 1 hour of incubation with the material with silver nanoparticles
in relation to control material (without silver nanoparticles).

| | Colony count | | |
|---|---|---|---|
| | Legionella pneumophilia | | |
| | dilution | | |
| | ×10³ | ×10⁴ | ×10⁵ |
| Control material | uncountable | 600 | 58 |
| (no silver) | | | |
| Test material | 0 | 0 | 0 |
| (with silver nanoparticles) | | | |

Tests have shown that after one hour of incubation of the material with silver nanoparticles, there has been total eradication of the bacterium Legionella pneumophilia serotype 1.

1. A bactericidal preparation characterised in that it comprises a nanosilver component in colloidal form, containing nanosilver particles in an amount of 5-4000 ppm complexed with polyvinyl alcohol (PVA) in an amount of 0.01-15%, in the presence of sodium or potassium nitrate at pH from 4.8 to 6.2 and a stabiliser dispersant in an amount of 0.01-12%, and, preferably, in the presence of a polymer in the form of ethyl polymethacrylate with molecular mass of 0.01-4000 kDa, said nanosilver component having been modified in the presence of nitric acid with polyethylene glycol having molecular mass of 400 at an amount of 0.1-45% and 30% hydrogen peroxide in an amount of 0.1-100 g/L.

2. The bactericidal nanopreparation according to claim 1, characterised in that the polymeric component is in the form of a dispersion.

3. The bactericidal nanopreparation according to claim 1, characterised in that the stabilizing dispersant is a polyoxyethylene sorbitant monooleate (TWEEN).
